(19) United States
(12) Patent Application Publication
(10) Pub. No.: US 2006/0285588 A1
(43) Pub. Date: Dec. 21, 2006

(54) Video encoder and encoding method with updateable quantization table

(75) Inventors: Kuang-Yu Tang, XiZhi City (TW); Kuo-Chang Fu, XiZhi City (TW); Jen-chung Wang, XiZhi City (TW)

Correspondence Address: ANTHONY R. BARKUME, 20 GATEWAY LANE, MANORVILLE, NY, 11949, US

(73) Assignee: Imagia Technologies

(21) Appl. No.: 11/158,590

(22) Filed: Jun. 21, 2005

(51) Int. Cl. H04N 11/04; H04N 7/12; H04B 1/66; H04N 11/02

(52) U.S. Cl. 375/240.03; 375/240.12

(57) ABSTRACT

A video encoder having an updateable quantization table for compressing a video information is proposed. The features are: the video encoder has a RAM to store the quantization table; the quantization table can be updated according to the special environments or user demands to change the choice standard of quantization.

### FIELD OF THE INVENTION

The present invention relates to a video encoder, especially to the video encoder having RAM (Random Access Memory) for storing a quantization table; and the quantization table can be updated according to the environments or user demands to change the quantization selection.

### BACKGROUND OF THE INVENTION

Because of the limitation of bandwidth and stored media, the video compression technology is invented for the effectually transforming and storing requirements. For example, one 640×480, 30 frame/s and 30 minutes full color video needs about 47 GB storing spaces if it is not compressed. Such is not efficient.

In order to meet the video compression requirements, the prior arts eliminate the redundancy and the information which naked eye hardly tells, and entropy coding method. FIG. 1 shows a known video encoder. In video encoder 10, transform unit 101 transforms the video information of spatial domain into frequency domain by DCT (Discrete Cosine Transformation) method. Then the quantization will be processed. The quantization unit 102 will proceed the selection in the video information of the frequency domain according to the quantization table 1021 so as to diminish the high frequency information which cannot be found by naked eyes. Finally, we process entropy coding 103, such as Huffman or Arithmetic coding, and store the information effectually.

Simply speaking, the above quantization processes take a division operation for the video information of frequency domain, and the denominator will change for different frequencies in the quantization table, that is, the choice of quantization scale. Generally, naked eyes can't tell high frequency information, so we have to use larger scale and try to diminish the high frequencies. For low frequencies, we use smaller scale so that the information will approach to the original sources.

In encoding compressed video information, the quantization table of the former video encoder is constant. In other words, no matter what is the video information, the standard for diminishing different frequencies is the same. This method will lead some problems; for some special environments and backgrounds, it's hard to offer better compress ratio. If the compression is too much or less, it will cause bad image quality. For example, when there is high frequency information such as hair blowing in short distance, the compression ratio of the same quantization table may be too high; it will not be seen after encoding. Another example, while the image background is static, the compression ratio of the same quantization table may be too small and it will waste too much store space. Therefore, we have to improve prior technology.

### SUMMARY OF THE INVENTION

An objective of the present invention is to build a video encoder which can update quantization table and store the table into RAM, and also the table can be updated depending on user demands and special environments. By changing the choice standard of quantization, we can make the compression results better.

Another objective of the present invention is to offer a video encoding method so as to update the quantization table according to the video content in video encoding, then we diminish the excess signals elastically according to the video information of frequency domain that quantified by quantization table. At the same time, we can not only raise the compress ratio and maintain the image quality or keep the ratio but also raise the image quality.

### BRIEF DESCRIPTION OF THE INVENTION

According to the present invention, a video encoder having an updateable quantization table for compressing a video information is proposed. The features are: the video encoder has a RAM to store the quantization table; the quantization table can be updated according to the special environments or user demands to change the choice standard of quantization.

In accordance with one aspect of the present invention, the video encoder is Mpeg2 or Mpeg4 video encoder.

In accordance with one aspect of the present invention, the RAM is a volatile memory or a NVRAM (Non-Volatile Random Access Memory).

In accordance with one aspect of the present invention, the volatile memory is SRAM (Static Random Access Memory).

In accordance with one aspect of the present invention, the video encoder includes a storage device to store several quantization tables of different conditions to update the quantization table in the RAM.

According to the present invention, a video encoding method comprises steps of: providing a video information; transforming the video information into that of frequency domain; updating a quantization table according to the video information; Quantifying the video information of frequency domain according to the quantization table.

In accordance with one aspect of the present invention, the video encoder method can be Mpeg2 or Mpeg4 method

In accordance with one aspect of the present invention, the quantization table is stored in the RAM.

In accordance with one aspect of the present invention, the RAM is volatile memory or NVRAM (Non-Volatile Random Access Memory).

In accordance with one aspect of the present invention, the volatile memory is SRAM (Static Random Access Memory).

In accordance with one aspect of the present invention, the video encoder includes a storage device to store several quantization tables of different conditions to update the quantization table in the RAM.

The present invention may best be understood through the following description with reference to the accompanying drawings, in which:

### BRIEF DESCRIPTION OF THE DRAWINGS

FIG. 1 shows the diagram of the prior video encoder;

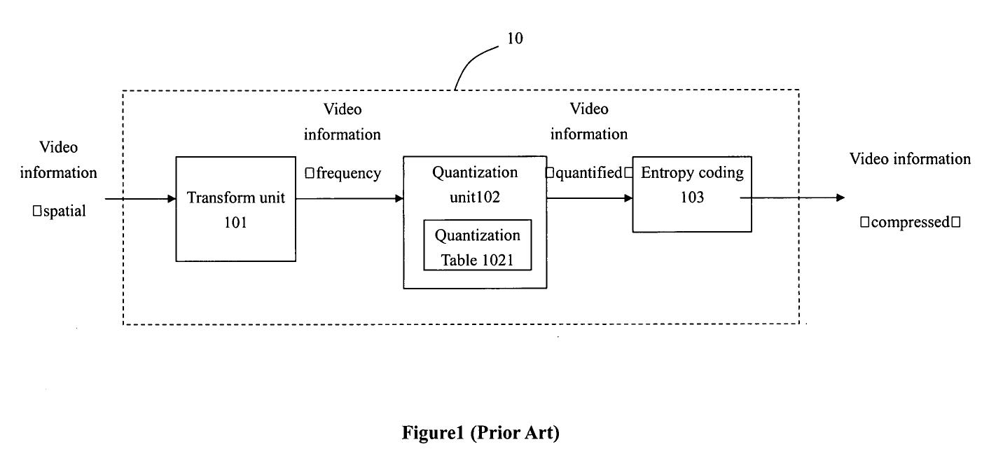

FIG. 2 shows the video encoder with updateable quantization table according to the present invention; and

FIG. 3 shows another video encoder with updateable quantization table according to the present invention.

### DETAILED DESCRIPTION OF THE PREFERRED EMBODIMENT

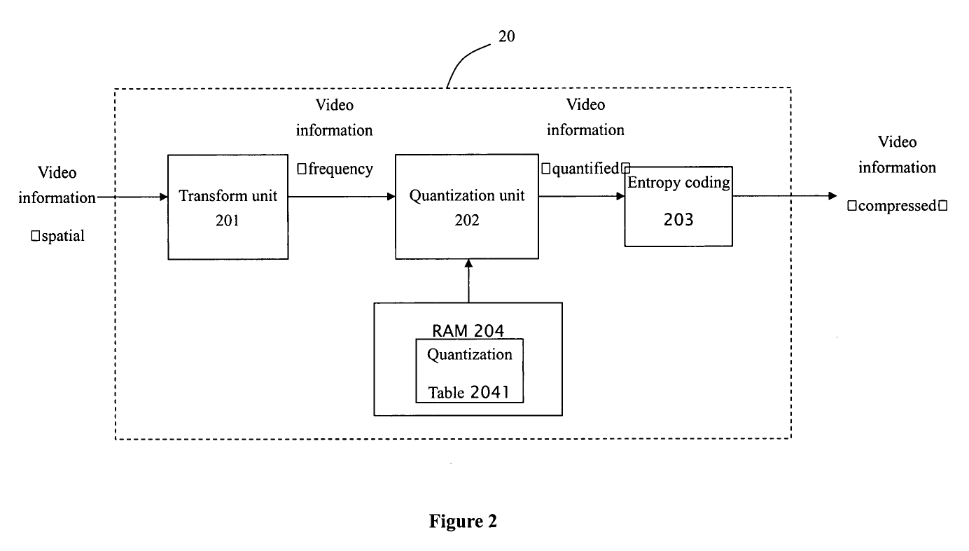

FIG. 2 shows the video encoder with updateable quantization table according to the present invention. In the video encoder 20, the video information of spatial domain inputs the transform unit 201, then we transform into the video information of frequency domain by DCT method and quantify by quntization unit 202. Finally, we process entropy encoding 203 and store the data by Huffman or Arithmetic coding method.

The quantization table 2041 in the quantization process is stored in the SRAM 204, which can be updated in video encoder 20 so that the choice standard of different frequency can be updated by the video information. For example, if there are more low frequency signals than high frequency signals, we can generally use a large scale for high frequency signals to make it zero, and use a small scale for low frequency signals so that the information will not much different with the original. However, if there are only high frequencies, we can update the quantization table by smaller scale so that we can see the video clearly after encoding.

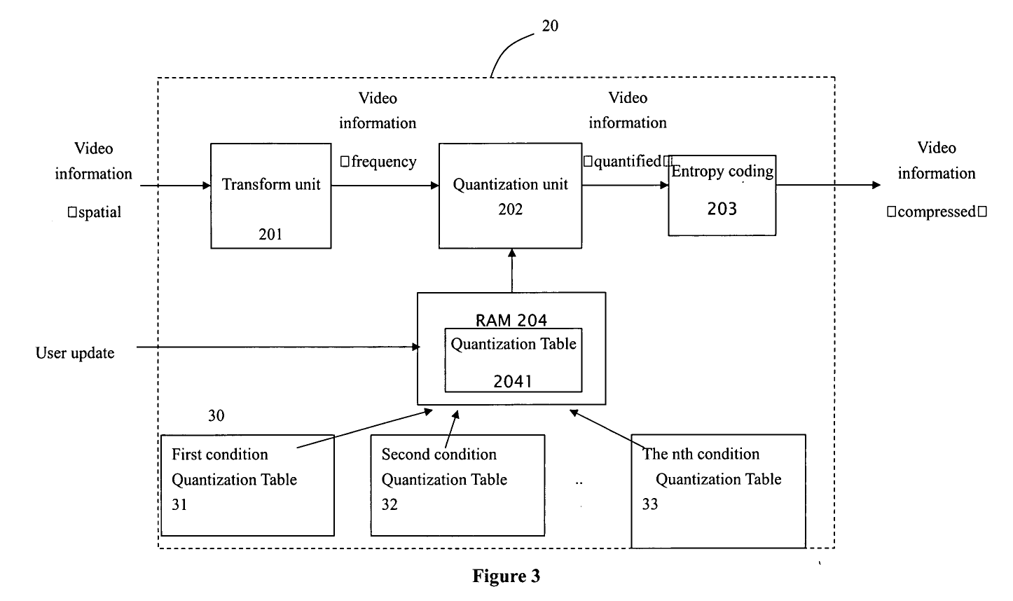

FIG. 3 shows another video encoder with updateable quantization table according to the present invention. There is more a memory device 30 for presetting some quantization tables depending to some conditions. For example, the first condition quantization table is for a static image, and the second condition quantization table is for a night image, and the Nth condition quantization table is for a snow ground image. Besides, user can also update the quantization table 2041. Therefore, it makes the present invention more flexible for some special situations and updates it by default quantization table.

Of course, besides Mpeg2 and Mpeg4, the present invention can use other compression methods with quantization table. There are two processes for general quantization: scalar and vector. MPEG series use scalar, but vector quantization is another table, so we can also use this method on vector quantization. The targets for changing quantization table are: 1. to raise compress ration without changing image quality, and 2. to raise image quality and keep the same compress ratio.

In conclusion, the present invention improves the prior technology to build a video encoder with updateable quantization table and store it into the RAM. And the quantization table can be updated according to user demands and special environments, so we can change the quantization choice standard to make the video compress encoding results perfect. The present invention provide a video encoding method so that we can update quantization table according to the video information while video encoding, and diminish the excess signals elastically according to the video information of frequency domain that quantified by quantization table.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video encoder having an updateable quantization table for compressing video information; said video encoder having a RAM to store said quantization table; said quantization table being updated according to a user demand or a special environment to change the choice standard of quantization.

2. The video encoder according to claim 1 wherein said video encoder is Mpeg2 or Mpeg4 video encoder.

3. The video encoder according to claim 1 wherein said RAM is a volatile memory or a NVRAM (Non-Volatile Random Access Memory).

4. The video encoder according to claim 3 wherein said volatile memory is SRAM (Static Random Access Memory).

5. The video encoder according to claim 3 wherein said video encoder includes a storage device to store several quantization tables of different conditions to update said quantization table in the RAM.

6. A video encoding method comprises steps of:
providing a video information;
transforming said video information into that of frequency domain;
updating a quantization table according to said video information;
Quantifying said video information of frequency domain according to said quantization table.

7. The method according to claim 6 wherein said video encoder method can be Mpeg2 or Mpeg4 method.

8. The method according to claim 6 wherein said quantization table is stored in a RAM.

9. The method according to claim 8 wherein said RAM is a volatile memory or a NVRAM (Non-Volatile Random Access Memory).

10. The method according to claim 9 wherein said volatile memory is SRAM (Static Random Access Memory).

11. The method according to claim 9 wherein said video encoder includes a storage device to store several quantization tables of different conditions to update said quantization table in said RAM.
